(19) United States
(12) Patent Application Publication
(10) Pub. No.: US 2005/0040102 A1
(43) Pub. Date: Feb. 24, 2005

(54) Centrifuge bag having integrated o-rings

(76) Inventor: Steve Wiater, Southwick, MA (US)

Correspondence Address: CANTOR COLBURN LLP, 55 Griffin Road South, Bloomfield, CT, 06002, US

(21) Appl. No.: 10/898,604

(22) Filed: Jul. 23, 2004

Related U.S. Application Data
(60) Provisional application No. 60/490,101, filed on Jul. 25, 2003.

(51) Int. Cl. B01D 29/085

(52) U.S. Cl. 210/512.1; 494/16

(57) ABSTRACT

A centrifuge bag comprising a first sheet having a first o-ring integrally formed on an interior surface of the first sheet. A second sheet is joined to the first sheet at a periphery of the first sheet and the second sheet. The second sheet has an interior surface facing the interior surface of the first sheet and a second o-ring integrally formed on the interior surface of the second sheet.

### CROSS REFERENCE TO RELATED APPLICATIONS

This application claims the benefit of U.S. provisional patent application Ser. No. 60/490,101 filed Jul. 25, 2003, the entire contents of which are incorporated herein by reference.

### BACKGROUND

The invention relates to centrifuge bags for processing fluid, such as blood, and in particular to a centrifuge bag having an integrally formed o-ring. Existing centrifuge devices employ centrifuge bags for containing blood during the centrifuge process. In existing systems, separate o-rings are used to provide a seal between a centrifuge bag and a spindle. The separate o-rings increase cost and complexity due to the need to manufacture/purchase, stock and assemble extra separate components.

### SUMMARY OF THE INVENTION

Embodiments of the invention include a centrifuge bag comprising a first sheet having a first o-ring integrally formed on an interior surface of the first sheet. A second sheet is joined to the first sheet at a periphery of the first sheet and the second sheet. The second sheet has an interior surface facing the interior surface of the first sheet and a second o-ring integrally formed on the interior surface of the second sheet.

Embodiments of the invention include a method of making a centrifuge bag including obtaining a first sheet having a first opening formed therein and integrally forming a first o-ring on an interior surface of the first sheet around the first opening. A second sheet is obtained having a second opening formed therein and a second o-ring is integrally formed on an interior surface of said second sheet around said second opening. The first sheet and said second sheet are joined at a periphery of said first sheet and said second sheet.

Embodiments of the invention include a centrifuge assembly having a centrifuge bag comprising a first sheet having a first o-ring integrally formed on an interior surface of the first sheet. A second sheet is joined to the first sheet at a periphery of the first sheet and the second sheet. The second sheet has an interior surface facing the interior surface of the first sheet and a second o-ring integrally formed on the interior surface of the second sheet. A central plate is positioned between the first and second sheets. A first outer plate is positioned at an outer surface of the first sheet compressing the first sheet against the central plate. A second outer plate is positioned at an outer surface of the second sheet compressing the second sheet against the central plate. An inlet tube extends through the central plate and into an interior space between the first sheet and the second sheet.

### BRIEF DESCRIPTION OF THE DRAWINGS

FIG. 1 is a top view of a centrifuge bag in an embodiment of the invention.

FIG. 2 is a cross-sectional view taken along line 2-2 of FIG. 1.

FIG. 3 is an enlarged view of a cross section of one o-ring.

FIG. 4 depicts a process for making a centrifuge bag in embodiments of the invention.

FIG. 5 depicts a centrifuge assembly including an exemplary centrifuge bag.

### DETAILED DESCRIPTION

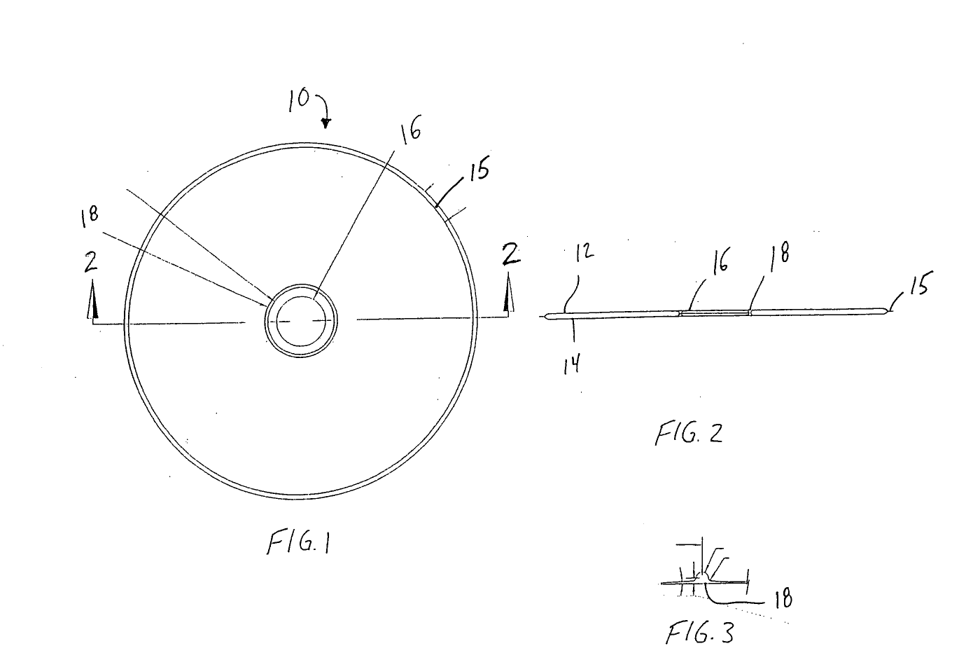

FIG. 1 is a top view of a centrifuge bag 10 in an embodiment of the invention. The centrifuge bag 10 is made from two sheets 12 and 14 (FIG. 2) that are sealed around the periphery. In one embodiment, the sheets 12 and 14 are thermoplastic material and are sealed around the periphery 15 by applying energy (RF welding, ultrasonic welding, heat pressing) around the periphery.

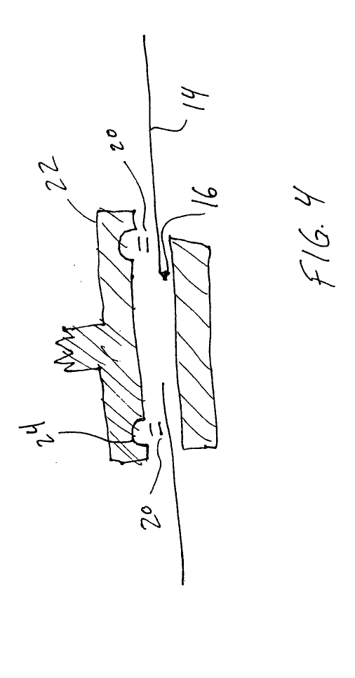

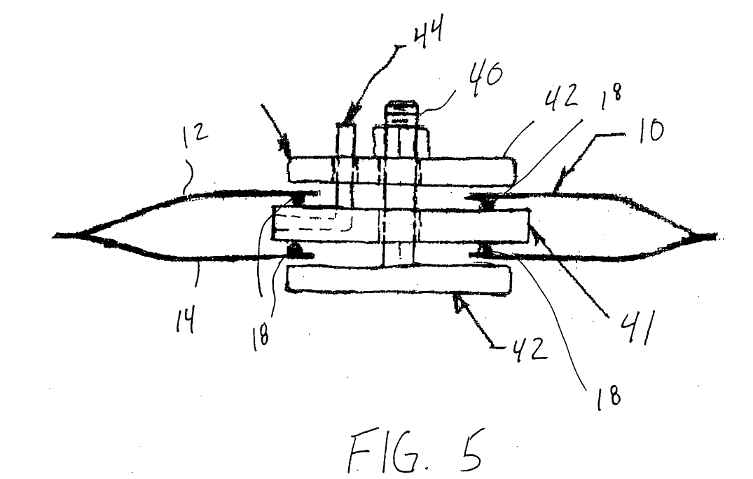

An opening 16 is provided in sheets 12 and 14, to receive a centrifuge spindle as shown in FIG. 5. The interior surface of sheets 12 and 14 includes integrally formed o-rings 18. FIG. 3 is an enlarged view of a cross section of one o-ring 18. The o-ring is a raised section of material having, for example, a semi-circular cross-section. It is understood that other o-ring cross sections may be used. As shown in FIG. 4, the o-ring is formed on sheet 14 by placing one or more rings of planar, thermoplastic material 20 on the interior surface of sheet 14. In one embodiment, sheet 14 is 0.0010 inches thick and two rings 20, each 0.0010 inches thick are used. A press 22 has a recess 24 in the shape of o-ring 18 having, for example, a semi-circular cross section. Press 22 is placed in contact with rings 20 and sheet 14 and energy (e.g., heat) is applied. Rings 20 melt, assume the shape of cavity 24 and are fused with sheet 14. The o-ring 18 on top sheet 12 is formed in the same manner. Sheets 12 and 14 may then be joined at the periphery.

FIG. 5 depicts a centrifuge assembly including centrifuge bag 10. The centrifuge assembly includes a spindle 40, central plate 41 and two outer plates 42. The central plate 41 is disposed between sheets 12 and 14 and an air/fluid inlet tube 44 extends from one outer plate 42, through central plate 41 and into the interior of centrifuge bag 10. A nut or other force applying member (e.g., spring clamp) compresses the outer plates 42 towards central plate 41. O-rings 18 contact central plate 41 to make an air/fluid tight seal.

The integral o-ring has been described with respect to a dual o-ring configuration for a blood centrifuge. It is understood that the integral o-ring may be employed in a variety of configurations (e.g., single, integral o-ring) in a variety of applications. The integral o-ring finds utility in any application where a separate gasket or seal is used.

While the invention has been described with reference to exemplary embodiments, it will be understood by those skilled in the art that various changes may be made and equivalents may be substituted for elements thereof without departing from the essential scope thereof. Therefore, it is intended that the invention not be limited to the particular embodiments disclosed for carrying out the invention, but that the invention will include all embodiments falling within the scope of the appended claims.

1. A centrifuge bag comprising:
a first sheet;
a first o-ring integrally formed on an interior surface of said first sheet;
a second sheet joined to said first sheet at a periphery of said first sheet and said second sheet, said second sheet having an interior surface facing said interior surface of said first sheet; and
a second o-ring integrally formed on the interior surface of said second sheet.

2. The centrifuge bag of claim 1 wherein:
said first sheet is made from a thermoplastic.

3. The centrifuge bag of claim 2 wherein:
said first o-ring is thermally formed on said first sheet.

4. The centrifuge bag of claim 1 wherein:
said second sheet is made from a thermoplastic.

5. The centrifuge bag of claim 4 wherein:
said second o-ring is thermally formed on said second sheet.

6. A method of making a centrifuge bag comprising:
obtaining a first sheet having a first opening formed therein;
integrally forming a first o-ring on an interior surface of said first sheet around said first opening;
obtaining a second sheet having a second opening formed therein;
integrally forming a second o-ring on an interior surface of said second sheet around said second opening;
joining said first sheet and said second sheet at a periphery of said first sheet and said second sheet.

7. The method of claim 6 wherein:
said integrally forming said first o-ring includes placing at least one sheet of thermoplastic material around said first opening and applying energy to said at least one sheet to form said first o-ring.

8. The method of claim 7 wherein:
said applying energy includes applying heat using a press to shape said at least one sheet to form said first o-ring.

9. The method of claim 6 wherein:
said integrally forming said second o-ring includes placing at least one sheet of thermoplastic material around said second opening and applying energy to said at least one sheet to form said second o-ring.

10. The method of claim 9 wherein:
said applying energy includes applying heat using a press to shape said at least one sheet to form said second o-ring.

11. A centrifuge assembly comprising:
a centrifuge bag having:
a first sheet;
a first o-ring integrally formed on an interior surface of said first sheet;
a second sheet joined to said first sheet at a periphery of said first sheet and said second sheet, said second sheet having an interior surface facing said interior surface of said first sheet; and
a second o-ring integrally formed on the interior surface of said second sheet;
a central plate positioned between said first and second sheets;
a first outer plate positioned at an outer surface of said first sheet compressing said first sheet against said central plate;
a second outer plate positioned at an outer surface of said second sheet compressing said second sheet against said central plate;
an inlet tube extending through said central plate and into an interior space between said first sheet and said second sheet.
